(19) United States
(12) Patent Application Publication
(10) Pub. No.: US 2010/0018532 A1
(43) Pub. Date: Jan. 28, 2010

(54) Filter Pouch for Containing Aerosol Spray of a Cough

(76) Inventor: Steven J. Moravec, Chicago, IL (US)

Correspondence Address: BERENATO & WHITE, LLC, 6550 ROCK SPRING DRIVE, SUITE 240, BETHESDA, MD, 20817, US

(21) Appl. No.: 12/344,281

(22) Filed: Dec. 25, 2008

Related U.S. Application Data
(60) Provisional application No. 61/083,057, filed on Jul. 23, 2008.

(51) Int. Cl. A62B 23/00

(52) U.S. Cl. 128/205.29

(57) ABSTRACT

The cough pouch contains the infectious aerosol spray of a cough or sneeze in medical-grade filter pouch protecting the general public from disease-carrying viruses and bacteria. It also protects the cougher's hand from being contaminated. The reusable disposable cough pouch opens and reseals with light finger pressure when used in a “cupped” hand. Its small size and portability allows for discrete use in public situations, and is easily carried in a purse, pocket or similar small container.

This application claims the benefit of prior filed U.S. Provisional Application Ser. No. 61/083,057, filed Jul. 23, 2008.

### BACKGROUND OF THE INVENTION

1. Field of the Invention

The invention relates generally to a filter pouch which contains the aerosol spray generated by a cough.

2. Background

In modern society it is inevitable that persons with colds, influenza, and similar illnesses crowd together in a variety of circumstances. In each, it is unavoidable that illnesses pass from one-to-the-other because of close personal proximity and the airborne nature of the distribution of pathogens. A cough or sneeze in such circumstances greatly increases the number of airborne pathogens exacerbating the spread of diseases.

Currently there are a number of solutions for containing the pathogenic aerosol spray of a cough. Some of these solutions do not adequately contain the aerosol spray while others are impractical for use by the general public. These solutions fail to protect public and personal health.

Tissues and handkerchiefs do not fully contain the aerosol spray of a cough. The imprecise nature of their design allows for pathogens to escape into the air. Furthermore, the hand itself is not covered and protected from the aerosol spray allowing it to be contaminated with viruses and bacteria.

Facemasks are unsightly and highly unlikely to be worn by persons in public. Other known solutions are generally bulky, complicated devices. Their large size prevents a person from using them discretely. Their complicated designs would be expensive to manufacture and sell to consumers, reducing their impact as a viable means to protect public health. Their large size would also make it difficult for people to transport in a pocket, purse or other small container.

The present invention fills a void in public and personal health hygiene. Numerous infectious diseases are spread by coughing which expels bacteria and viruses into the air and contaminates the cougher's hand. It would be desirable to have a device that prevents the spread of these infectious diseases by containing the aerosol spray of a cough. Furthermore, it would be desirable that the device be small, portable, and easily concealed when being used. Still further, the device should be simple to use and made of inexpensive materials that can be mass produced and packaged in multiple units.

### SUMMARY OF THE INVENTION

The present invention advantageously fills the aforementioned deficiencies by providing a filter pouch which contains the aerosol spray of a cough and muffles the sound of the cough.

The present invention is, when in an expanded condition, a substantially cylindrical pouch sealed on all sides except for the circular opening. It is made of flexible medical-grade filter material similar to that of a hospital surgical mask. The present invention has two key components and one important feature. Component one is a flexible, hinged insert that is embedded in the pouch's circular opening. The insert provides flexible rigidity to the opening and allows light finger pressure of a cupped hand to open and close the pouch. The second key component is the adhesive strip that lines the circular opening. The adhesive's bond is strong enough to keep the pouch closed when fingers press it closed, yet releases when finger pressure is applied to open the pouch. The combination of the rigid/flexible insert and the adhesive strip allows the pouch to be resealed and reused on command in multiple successive instances of coughing. The present invention's key feature is its small size that fits in a cupped hand allowing for discrete use and portability.

The present invention's optional features are size and color. Various sizes could be manufactured for adults and children or different hand sizes. Small, medium, large and ex-large sizes would accommodate all persons. The filter material can be manufactured from a variety of colors for personal preference.

The present invention has distinct advantages over products designed or currently in use whose aim is to prevent the spread of infectious viruses and bacteria by containing the aerosol spray of a cough. The present invention fully contains the aerosol spray of a cough and substantially muffles its sound. It also protects the hand from being contaminated by the infectious aerosol spray. It is small in size, fitting into a cupped hand that a person would use to cover their mouth when coughing. This small size allows for discrete use in nearly all situations. Its small size also allows it to be easily carried in a pocket, purse or other small container.

The present invention has additional unique features. The opening seals and reopens with light finger pressure making the pouch reusable. It is simple in design and made of inexpensive material that can be economically mass produced. Its low cost will aid in its widespread use by the general public.

Key unique structural elements of the present invention:

1) Small size that fits into a “cupped hand”

2) Sealed on all sides except the opening. This allows the aerosol spray and sound of a cough to be contained

3) Made of a filter material that allows air to pass, preventing a backflow of the aerosol spray into the mouth

4) Filter material captures the vast majority of viruses and bacteria present in a cough

5) Hinged, flexible insert that is embedded in the pouch's opening. The insert provides rigidity to the circular opening of the pouch so it does not collapse during use. The insert allows light finger pressure of a cupped hand to open and close the pouch

6) Adhesive strip that lines the inside of the circular opening. The adhesive strip's bond is strong enough to hold the pouch closed after light finger pressure closes the opening. The adhesive strip's bond is weak enough so that light finger pressure will reopen the pouch.

7) The combination of the hinged, flexible insert and the adhesive strip allows the present invention to be resealed and reopened for multiple uses.

Finally, it is an object of the present invention to provide a filter pouch which contains the aerosol spray of a cough and which does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a side and top view of the hygienic cough pouch.

FIG. 2 is a perspective view of the couch pouch.

FIG. 3 is a user's hand holding the cough pouch

FIG. 4 is the cough pouch in use.

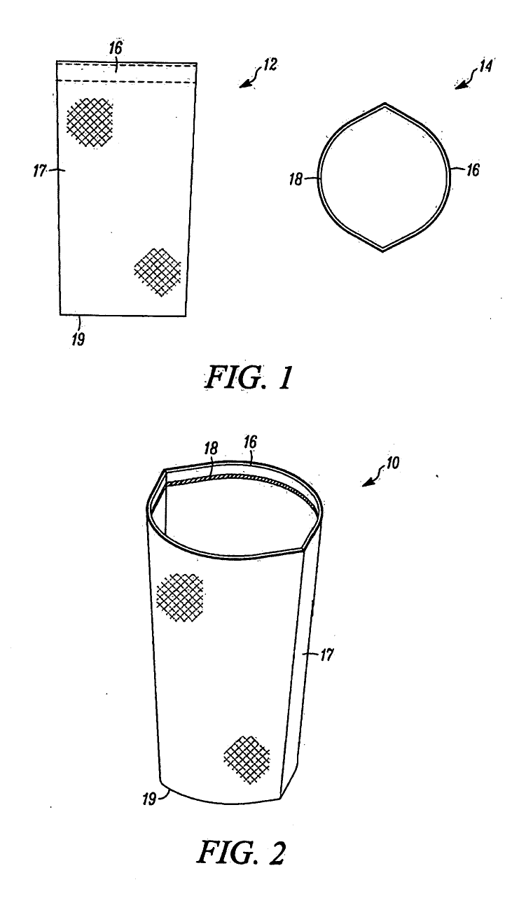

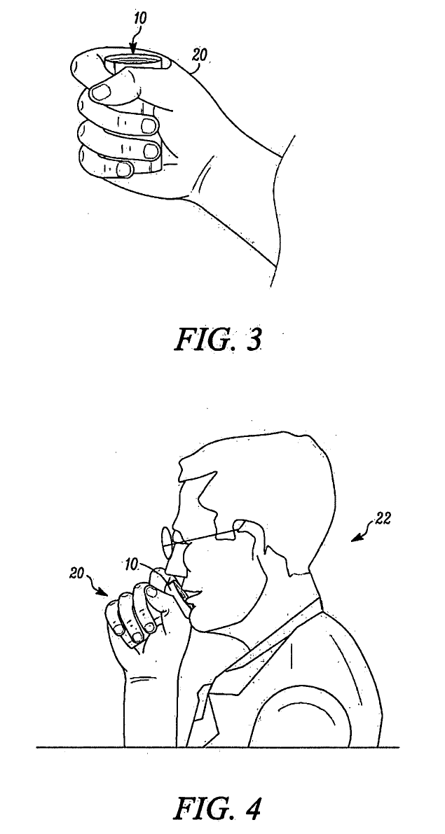

### DETAILED DESCRIPTION OF THE INVENTION

With reference to the drawing Figures: The cough pouch 10 is made up of a pair of side panels 12 and a bottom panel 19 sealed one to the other except at the top pouch opening 14. The side panels 12 of the pouch 10 are preferably made from 3-ply disposable surgical face mask material 17. (Such a filter mask is disclosed in U.S. Pat. No. 4,662,005, the contents of which are incorporated herein by reference.) This material 17 may be optionally treated with an anti-bacterial agent to further reduce the spread of trapped contaminants. Material 17 is selected such that is has sufficient porosity to allow the rapid burst of air from a cough to pass through the material without risk of back-flow into the mouth, while at the same time capturing the aerosol contaminants. The top opening 14 is biased in an elongated closed position by insert 16 (a plastic insert similar to a collar stay) wherein the respective opposed edges of the opening 14 are sealed with a light adhesive strip 18 (similar to a Post-It™ multi-stick re-useable adhesive). The hinged plastic insert allows for the pouch to be opened and closed with light finger pressure; The adhesive strip will hold the pouch closed when the “cupping” pressure of the thumb and index finger is used close the pouch. The adhesive strip also allows the pouch to be re-opened when the thumb and index finger pinch the hinged plastic insert.

In use, a person 22 discretely maneuvers their hand 20 including the opened pouch 10 to the proximity of their mouth and coughs into the pouch 10. Aerosol borne contaminants are captured in the pouch whereupon the pouch can be sealed by the combined action of the resilient insert 16 and sealing strip 18 and maintained in the hand 20 for further use.

The key components of the present invention are the flexible, hinged insert embedded in the opening and an adhesive strip that lines the inner rim of the opening. The insert provides a degree of rigidity to the circular opening allowing it to maintain its shape, yet it is flexible enough to allow light finger pressure to open and close the pouch. The adhesive strip provides a bond strong enough to hold the pouch closed when light finger pressure is applied with a “cupped” hand, yet the adhesive bond is weak enough to allow light finger pressure to open the pouch. It is the combination of the hinged insert and the adhesive strip that allows the present invention to be resealed and be reusable.

The overarching goal of the present invention is to protect the public's health. The pouch is ideally suited for use in classrooms, boardrooms, airplanes, elevators or any other confined space where a person's health is jeopardized by pathogenic viruses and bacteria present in the aerosol spray of a cough. By preventing illnesses and diseases the present invention will save millions of dollars in medicines, physicians visits, and lost work days.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. A re-sealable filter pouch, comprising:
a body portion, capable of being hand held, made of an air filtering material, sealed so as to form a pouch having respective sides and a bottom and an open slotted top, said slotted top including a rim portion equipped with an elongated resilient means for maintaining said open slotted top in an elongated closed position wherein opposed sides of said rim touch one side against the other, said rim further including a light multi-use adhesive thereon for sealing said sides of said rim one against the other such that light finger induced pressure on respective opposed ends of said slotted top in a closed position result in said slotted top opening into an open receiving configuration.

2. A re-sealable pouch as in claim 1, wherein:
said filter material is 3-ply surgical mask mesh.

3. A re-sealable pouch as in claim 1, wherein:
said resilient means is a hinged plastic insert.
